(19) United States
(12) Patent Application Publication
(10) Pub. No.: US 2015/0022893 A1
(43) Pub. Date: Jan. 22, 2015

(54) Diffraction Grating and Method for the Production Thereof

(71) Applicants: Fraunhofer-Gesellschaft zur Förderung der angewandten Forschung e.V., Muenchen (DE); Friedrich-Schiller-Universität Jena, Jena (DE)

(72) Inventors: Frank Fuchs, Jena (DE); Uwe D. Zeitner, Weimar (DE); Ernst-Bernhard Kley, Jena (DE)

(21) Appl. No.: 14/381,535

(22) PCT Filed: Feb. 25, 2013
(86) PCT No.: PCT/EP2013/053715

§ 371 Date: Aug. 27, 2014

(30) Foreign Application Priority Data
Feb. 27, 2012 (DE) 10 2012 101 555.4

(51) Int. Cl. G02B 5/18; B05D 5/06

(52) U.S. Cl. CPC G02B 5/1861; G02B 5/1866; G02B 5/1847; B05D 5/061; G02B 2005/1804; B05D 2350/30
USPC 359/572; 359/569; 427/162

(57) ABSTRACT

A diffraction grating includes a grating area having, in a direction running parallel to a substrate, a periodic arrangement of first areas with a first grating material and second areas with a second grating material. The first grating material and the second grating material are solid materials with different indices of refraction. A reflection-reducing or reflection-increasing layer system having at least two layers with different indices refraction. The reflection-reducing or reflection-increasing layer system is arranged on one side of the grating area facing away from the substrate, and an additional layer system having at least two layers with different indices of refraction is arranged between the substrate and the grating area. A method for producing the diffraction grating is also specified.

This patent application is a national phase filing under section 371 of PCT/EP2013/053715, filed Feb. 25, 2013, which claims the priority of German patent application 10 2012 101 555.4, filed Feb. 27, 2012, each of which is incorporated herein by reference in its entirety.

### TECHNICAL FIELD

The invention relates to a diffraction grating and a method for the production thereof.

### BACKGROUND

Diffraction gratings are characterized by a periodic arrangement of a unit cell. This causes periodic interference of the propagation of an electromagnetic wave, in particular light. The influence of the propagation of the electromagnetic waves occurs either due to a local change of the absorption or of the propagation speed of the wave incident on the grating.

Such a periodic interference is generated, for example, by a change of the local index of refraction of an otherwise homogeneous and typically transparent medium. In this case, the diffraction grating is referred to as an index grating or a volume grating.

Alternatively, a periodic interference of the propagation of the electromagnetic wave is generated by a suitable surface profile on a transparent or reflective substrate. In this case, the diffraction grating is a transmissive or reflective surface grating.

The desired optical effect of a diffraction grating typically consists of deflecting light incident on the diffraction grating with high efficiency in a desired order of diffraction. The diffraction efficiency 11 is in this case defined as ηₘ=Pₘ/Pᵢₙ, wherein Pᵢₙ is the light power incident on the grating and Pₘ is the light power deflected in the mth order of diffraction.

The index contrast, i.e., the difference of the indices of refraction Δn of the grating regions, is typically comparatively small in volume gratings, for example, Δn<0.1, so that for a high diffraction efficiency, the thickness of the index-modulated region must be large. This results in low bandwidths of the diffraction efficiency in the wavelength range and angle of incidence range.

In contrast, surface gratings typically have a significantly higher index contrast, for example, Δn>0.45. The thickness or depth of the surface profile of the grating can accordingly be less, whereby the bandwidth increases. However, profile shapes adapted to the special application are required within the grating periods to achieve a high efficiency. In addition, reflection losses, which reduce the efficiency, can occur due to the large index contrast. In general, with increasing index contrast Δn, the bandwidth of the diffraction efficiency increases, but the reflection losses also increase simultaneously. A surface grating additionally has the disadvantage of a sensitive surface, which is difficult to clean in the event of soiling. This is disadvantageous in many applications.

### SUMMARY

Embodiments of the invention specify an improved diffraction grating, which is distinguished by increased diffraction efficiency and a comparatively insensitive surface. Furthermore, an advantageous method for producing such a diffraction grating is to be specified.

According to one embodiment, the diffraction grating comprises a substrate and a grating region, which has, in a direction extending parallel to the substrate, a periodic arrangement of first regions having a first grating material and second regions having a second grating material, wherein the first grating material and the second grating material are solid materials having different indices of refraction.

Furthermore, the diffraction grating comprises a reflection-reducing or reflection-increasing layer system, which has at least two layers having different indices of refraction and is arranged on a side of the grating region facing away from the substrate. The reflection-reducing or reflection-increasing layer system is preferably applied directly to the grating region.

Because the grating region is arranged in the diffraction grating between the substrate and the reflection-reducing or reflection-increasing layer system, the grating region is advantageously protected from external effects, in particular from dirt, moisture, or mechanical damage.

The reflection-reducing or reflection-increasing layer system on the side of the grating region facing away from the substrate is furthermore advantageously used to increase the diffraction efficiency of the diffraction grating.

For example, the diffraction grating can be a transmission grating, in which the light entry surface is the side of the layer system facing away from the substrate. In this embodiment, the layer system on the side of the grating region facing away from the substrate is a reflection-reducing layer system. Due to the reduction of the reflection of incident radiation, the diffraction efficiency is increased.

In an alternative embodiment, the diffraction grating is a reflection grating, in which the rear side of the substrate, which faces away from the grating region, is the light entry surface and light exit surface. In this embodiment, the layer system on the side of the grating region facing away from the substrate is a reflection-increasing layer system. The diffraction efficiency is increased by the increase of the reflection of the light on the rear side of the grating region.

In a preferred embodiment, a further layer system is arranged between the substrate and the grating region, which has at least two layers having different indices of refraction. In this embodiment, the grating region is thus enclosed on both sides by layer systems made in each case of at least two layers having different indices of refraction.

In one embodiment, the diffraction grating is a transmission grating, wherein the layer system on the side of the grating region facing away from the substrate and the further layer system, which is arranged between the substrate and the grating region, are each reflection-reducing layer systems. In this embodiment, the reflection of the incident radiation is reduced by the reflection-reducing layer system on the side of the grating region facing away from the substrate. The further reflection-reducing layer system between the substrate and the grating region advantageously reduces the reflection of the radiation transmitted from the grating region during the transition to the substrate. The substrate of the diffraction grating is preferably a transparent substrate, which has in particular a glass, for example, silica glass, or a transparent plastic.

In a further embodiment, the diffraction grating is a reflection grating, in which the rear side of the substrate, which faces away from the grating region, is the light entry surface and light exit surface, wherein the layer system on the side of the grating region facing away from the substrate is a reflection-increasing layer system, and the further layer system is a reflection-reducing layer system. In this case, advantageously, on the one hand, the reflection of the incident light is reduced and, on the other hand, the reflection on the rear side of the grating region is increased.

In an alternative embodiment, the diffraction grating is a reflection grating, in which the side of the layer system facing away from the substrate, which is arranged on the side of the grating region facing away from the substrate, is the light entry surface and light exit surface. The layer system on the side of the grating region facing away from the substrate is in this embodiment a reflection-reducing layer system, and the further layer system is a reflection-increasing layer system. In this case, advantageously, on the one hand, the reflection of the incident light is reduced and, on the other hand, the reflection on the rear side of the grating region is increased. In this manner, the diffraction efficiency is improved.

The first grating material, from which the first regions of the grating region are formed, has an index of refraction n₁>1. The second grating material, from which the second regions of the grating region are formed, has an index of refraction n₂>n₁. The first and second regions in the grating region thus advantageously form a periodic arrangement of regions having alternately low index of refraction and high index of refraction.

In a preferred embodiment, the following relationship applies for the difference of the indices of refraction Δn=n₂−n₁≧0.4. The diffraction efficiency of the grating is advantageously increased by a comparatively large difference between the indices of refraction of the grating materials of the first and second regions of the grating.

A comparatively high index of refraction contrast of preferably Δn≧0.4 in particular allows a high diffraction efficiency to be achieved with a comparatively thin grating region. A comparatively thin grating region advantageously simplifies the production of the grating region. The thickness of the grating region, i.e., the extension of the first and second regions in the direction extending perpendicular to the substrate, is preferably between 200 nm and 2000 nm.

The periodic arrangement of the first regions and second regions in the grating region preferably has a period length of less than 5 μm, particularly preferably of less than 1 μm.

In a preferred embodiment, the first grating material and the second grating material are dielectric materials. The dielectric materials can be in particular oxides, nitrides, oxynitrides, or fluorides, for example, SiO₂, TiO₂, Ta₂O₅, SiN, SiON, or MgF₂.

The first grating material is preferably a material having comparatively low index of refraction n₁, which is, for example, n₁≦1.6 or even n₁≦1.5. The first grating material can be, for example, a silicon oxide, in particular SiO₂. The second grating material advantageously has a comparatively high index of refraction n₂, which is, for example, n₂>1.6. The second grating material can be, for example, titanium dioxide (TiO₂) or tantalum pentoxide (Ta₂O₅).

In a preferred embodiment, the at least two layers of the reflection-reducing or reflection-increasing layer system and/or of the further layer system are each dielectric layers. The dielectric layers can have, like the grating materials of the grating region, dielectric materials in the form of oxides, nitrides, oxynitrides, or fluorides, for example, SiO₂, TiO₂, Ta₂O₅, SiN, SiON, or MgF₂.

In one embodiment, the at least two layers of the reflection-reducing or reflection-increasing layer system and/or of the further layer system have a first layer material and a second layer material, wherein the first layer material is identical to the first grating material and/or the second layer material is identical to the second grating material. In this case, at least one layer material of the reflection-reducing or reflection-increasing layer system and/or of the further layer system is thus identical to a grating material, or both layer materials are even identical to the grating materials. This advantageously simplifies the production of the diffraction grating.

The reflection-reducing or reflection-increasing layer system and/or the further layer system advantageously contain at least three, preferably at least four, or particularly preferably even at least five, layers having alternating indices of refraction. In particular, the reflection-reducing or reflection-increasing layer system and/or the further layer system are each optical interference layer systems, which are formed from alternating layers having alternately low index of refraction and high index of refraction.

The thicknesses of the alternating layers of the layer system are optimized, in dependence on the wavelength at which the diffraction grating is to be used, for a maximum transmission in the case of the reflection-reducing layer system or for a maximum reflection in the case of a reflection-increasing layer system. Such an optimization of the layer thicknesses to achieve a maximum transmission or reflection can be performed by a simulation calculation, for example, by means of RCWA (rigorous coupled wave analysis) in consideration of all layers of the diffraction grating including the grating region. In general, by increasing the number of the layers, a greater transmission and/or reflection can be achieved at the wavelength for which the diffraction grating is to be optimized, and/or the bandwidth of the reflection or transmission maximum can be increased.

Furthermore, an advantageous method for producing the diffraction grating is specified. In the method, firstly a substrate is provided and a periodic arrangement of recesses is produced in the substrate or alternatively in the material of a layer applied to the substrate. The solid material of the substrate or the solid material of the layer applied to the substrate functions as the first grating material.

The production of the periodic arrangement of recesses is preferably performed by a lithographic method, for example, by electron beam lithography.

In a further method step, a grating region is produced by filling the recesses with a further solid material, which functions as the second grating material. The first grating material and the second grating material have different indices of refraction. The filling of the recesses with the further solid material is preferably performed by means of atomic layer deposition (ALD). This method is particularly well suitable for filling the previously produced recesses with the further solid material, without pores or cavities arising in this case.

A reflection-reducing or reflection-increasing layer system, which has at least two layers having different indices of refraction, is subsequently deposited. The reflection-reducing or reflection-increasing layer system thus follows the grating region when viewed from the substrate and is preferably arranged on the grating region.

In an advantageous embodiment of the method, before the production of the grating region, a further layer system, which has at least two layers having different indices of refraction, is deposited. The further layer system can be a reflection-increasing layer system in the case of a reflection grating or a reflection-reducing layer system, in particular in the case of a transmission grating. The further layer system is arranged between the substrate and the grating region and can be applied to the substrate in particular.

The deposition of the reflection-reducing or reflection-increasing layer system or of the further layer system can be performed using coating methods known per se, in particular using PVD or CVD methods, for example, thermal vapor deposition, electron beam vapor deposition, or sputtering.

Further advantageous embodiments of the method result from the description of the diffraction grating and vice versa.

### BRIEF DESCRIPTION OF THE DRAWINGS

The invention will be explained in greater detail hereafter on the basis of an exemplary embodiment in conjunction with FIGS. 1 and 2.

In the figures:

FIG. 1 shows a schematic view of a cross section through a diffraction grating according to one exemplary embodiment of the invention; and

FIG. 2 shows a schematic view of the diffraction efficiency of the diffraction grating of FIG. 1 in dependence on the wavelength.

The illustrated components and the size relationships of the components to one another are not to be considered to be to scale.

### DETAILED DESCRIPTION OF ILLUSTRATIVE EMBODIMENTS

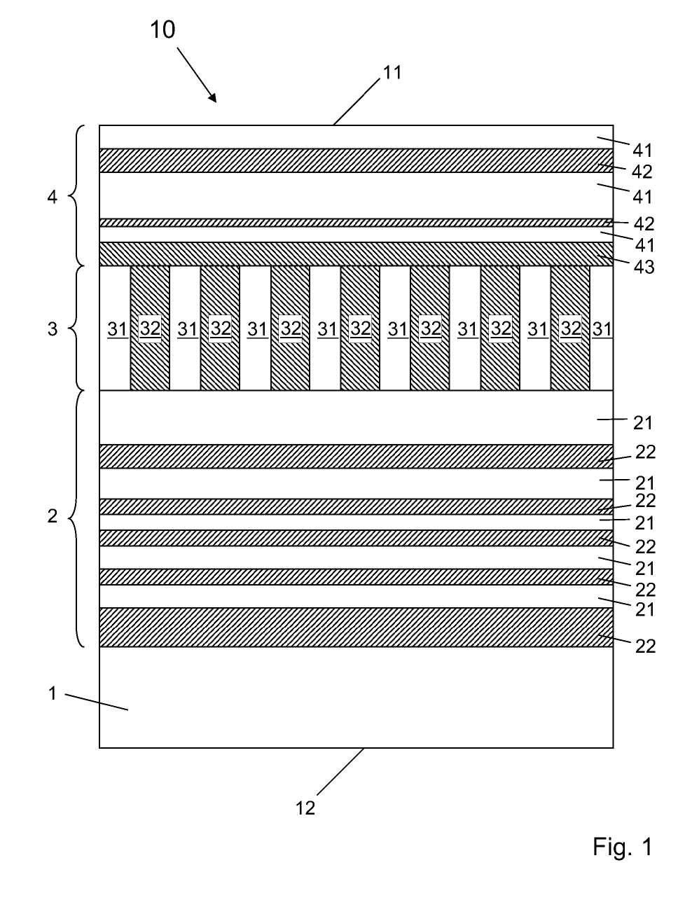

The diffraction grating 10 shown in FIG. 1 has a substrate 1, a grating region 3, a reflection-reducing layer system 4 on a side of the grating region 3 facing away from the substrate 1 and also a further reflection-reducing layer system 2 between the substrate 1 and the grating region 3.

In the exemplary embodiment, the diffraction grating 10 is a transmission grating, so that the substrate 1 is a transparent substrate. The substrate 1 of the diffraction grating 10 is a substrate made of silica glass (fused silica). Alternatively, another substrate 1, preferably made of a glass or a transparent plastic, could also be used.

The grating region 3 has a periodic arrangement of first regions 31 made of a first grating material and second regions 32 made of a second grating material.

The thickness of the grating region 3 of the diffraction grating 10 is preferably between 200 nm and 2000 nm and the period length is less than 5 μm, preferably less than 1 μm.

In the exemplary embodiment, for example, the thickness of the grating region is 1012 nm and the period length of the diffraction grating is 543 nm, wherein the width of the first regions 31 is 0.44 times the period length. The dimensions of the grating region are optimized such that a high diffraction efficiency in the wavelength range of 1000 nm to 1060 nm is achieved.

The first regions 31 and the second regions 32 of the diffraction grating 10 have indices of refraction which are different from one another. For example, the first grating material, from which the first regions 31 are formed, has an index of refraction n₁, and the second grating material, from which the second regions 32 are formed, has an index of refraction n₂>n₁. Preferably, n₂−n₁>0.4, since with a high index of refraction contrast, a high diffraction efficiency can be achieved with the diffraction grating 10. In the exemplary embodiment, the first grating material is SiO₂ and the second grating material is TiO₂.

A reflection-reducing layer system 4 is applied to the grating region 3 of the diffraction grating 10. The reflection-reducing layer system 4 is an interference layer system made of multiple dielectric layers 41, 42, 43. The reflection-reducing layer system 4 has a layer 43 having high index of refraction made of TiO₂, multiple layers 41 having low index of refraction made of SiO₂, and multiple layers 42 having high index of refraction made of Ta₂O₅.

In the exemplary embodiment, the reflection-reducing layer system 4 contains, starting from the grating region 3, a 200 nm thick layer 43 made of TiO₂, an 88 nm thick layer 41 made of SiO₂, a 74 nm thick layer 42 made of Ta₂O₅, a 353 nm thick layer 41 made of SiO₂, a 181 nm thick layer 42 made of Ta₂O₅, and a 172 nm thick layer 41 made of SiO₂.

The thicknesses of the individual layers 41, 42, 43 of the reflection-reducing layer system 4 are optimized such that the reflection is minimized in the wavelength range of 1000 nm to 1060 nm, which is provided for the use of the grating. The optimization of the layer thicknesses of the individual layers 41, 42, 43 of the reflection-reducing layer system 4 can be performed by a simulation calculation, for example, by means of RCWA (rigorous coupled wave analysis) in consideration of all layers of the diffraction grating 10, including the grating region 3.

Reflection losses on a radiation entry surface 11 of the diffraction grating 10 are reduced by the reflection-reducing layer system 4 following the grating region 3, and in this manner the diffraction efficiency of the diffraction grating 10 is increased. Furthermore, the grating region 3 is advantageously protected from external effects, in particular from mechanical damage, dirt, or moisture, by the reflection-reducing layer system 4. The diffraction grating 10 is therefore distinguished by improved long-term stability, in particular in comparison to surface gratings having an unprotected surface.

A further reflection-reducing layer system 2 is advantageously arranged between the substrate 1 and the grating region 3, which, like the reflection-reducing layer system 4, is an optical interference layer system made of multiple dielectric layers 21, 22, which alternately have a low and a high index of refraction. In the exemplary embodiment, the layers having low index of refraction are layers 21 made of SiO₂ and the layers having high index of refraction are layers 22 made of Ta₂O₅.

The further reflection-reducing layer system 2 contains, for example, starting from substrate 1, a 280 nm thick layer 22 made of Ta₂O₅, a 217 nm thick layer 21 made of SiO₂, a 77 nm thick layer 22 made of Ta₂O₅, a 241 nm thick layer 21 made of SiO₂, a 61 nm thick layer 22 made of Ta₂O₅, a 96 nm thick layer 21 made of SiO₂, a 119 nm thick layer 22 made of Ta₂O₅, a 281 nm thick layer 21 made of SiO₂, a 177 nm thick layer 22 made of Ta₂O₅, and a 404 nm thick layer 21 made of SiO₂.

In the present exemplary embodiment, the layer system 2 is, like the layer system 4 following the grating region 3, a reflection-reducing layer system. Due to the further reflection-reducing layer system 2, reflection losses on the side of the grating region 3 facing toward a radiation exit surface 12 of the diffraction grating 10 are reduced. In this way, the diffraction efficiency of the diffraction grating 10 is further increased.

In an alternative embodiment, the layer system 2 between the substrate 1 and the grating region 3 can be embodied as a reflection-increasing layer system. In this embodiment, the diffraction grating 10 is a reflection grating.

The layer thicknesses of the individual layers 21, 22 of the layer system 2 can be optimized, like the individual layers 41, 42, 43 of the layer system 4, using a simulation calculation, such that either a minimum reflection or a maximum reflection is achieved in a wavelength range provided for the use of the grating.

Furthermore, it is also possible to omit the layer system 2 between the substrate 1 and the grating region 3 (not shown). In this case, the grating region 3 can be implemented directly in a layer on the substrate 1 or in a surface region of the substrate 1.

The production of the diffraction grating 10 according to the exemplary embodiment is performed, for example, such that firstly the reflection-reducing layer system 2 is applied to the substrate 1. The layer system 2 made of the layers 21, 22 can be deposited on the substrate 1, for example, using vacuum coating methods, for example, thermal vapor deposition, electron beam vapor deposition, or sputtering.

After the application of the layer system 2, advantageously firstly a layer made of a first solid material, which functions as the first grating material for the first regions 31 of the diffraction grating, is applied to the entire area of the layer system 2. This can be a SiO₂ layer in particular.

In a further step, a periodic arrangement of recesses is produced in the layer made of the first grating material. The recesses are preferably linear, wherein the lines have the width of the second regions 32 provided for the diffraction grating. The production of the recesses can be performed, for example, by electron beam lithography in conjunction with a dry etching process.

The recesses produced in this manner for the second regions 32 are subsequently filled using a coating method with a second solid material, which functions as the second grating material. The second grating material can be TiO₂, for example.

The filling of the recesses to implement the second regions 32 is particularly advantageously performed by atomic layer deposition. This method is particularly well suitable for filling of comparatively deep regions having narrow width using a coating material. So as not to impair the diffraction efficiency of the diffraction grating 10, in particular, no cavities which have dimensions of greater than 20 nm are to occur in the second regions 32.

After the production of the grating region 3 by the filling of the recesses, the reflection-reducing layer system 4 is applied to the grating region 3. This can be performed by a vacuum coating method as in the case of the layer system 2.

The diffraction grating 10 according to the exemplary embodiment can be used in particular in pulse compressor arrangements for ultrashort laser pulses. In the exemplary embodiment of FIG. 1, the diffraction grating 10 is provided, for example, for a pulse compressor arrangement for laser pulses having a central wavelength of 1030 nm.

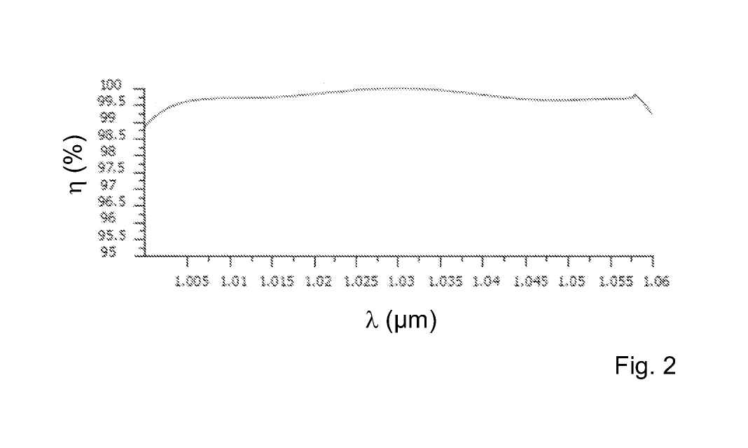

In FIG. 2, the diffraction efficiency η of the diffraction grating 10 for the −1 order of diffraction is shown in transmission upon illumination using TE-polarized light, i.e., in the case of a field vector of the electrical field which is oriented in parallel to the grating lines. A diffraction efficiency which is greater than 99% can advantageously be achieved using the diffraction grating 10 in the wavelength range of 1000 nm to 1060 nm.

The invention is not restricted by the description on the basis of the exemplary embodiments. Rather, the invention comprises any novel feature and any combination of features, which includes in particular any combination of features in the patent claims, even if this feature or this combination is not explicitly specified itself in the patent claims or exemplary embodiments.

1-12. (canceled)

13. A diffraction grating, comprising:
a substrate;
a grating region comprising, in a direction extending parallel to the substrate, a periodic arrangement of first regions having a first grating material and second regions having a second grating material, wherein the first grating material and the second grating material are solid materials having different indices of refraction;
a first layer system arranged on a side of the grating region facing away from the substrate, wherein the first layer system comprises a reflection-reducing or reflection-increasing layer system that has a plurality of layers having different indices of refraction; and
a further layer system arranged between the substrate and the grating region and that has a plurality of layers having different indices of refraction.

14. The diffraction grating according to claim 13, wherein the diffraction grating is a transmission grating, and wherein the first layer system and the further layer system are each reflection-reducing layer systems.

15. The diffraction grating according to claim 13, wherein the diffraction grating is a reflection grating and wherein the first layer system is a reflection-increasing layer system and the further layer system is a reflection-reducing layer system.

16. The diffraction grating according to claim 13, wherein the diffraction grating is a reflection grating and wherein the first layer system is a reflection-reducing layer system and the further layer system is a reflection-increasing layer system.

17. The diffraction grating according to claim 13, wherein the first grating material has an index of refraction n1>1 and the second grating material has an index of refraction n2>n1, wherein n2−n1≧0.4.

18. The diffraction grating according to claim 13, wherein the grating region has a thickness between 200 nm and 2000 nm.

19. The diffraction grating according to claim 13, wherein the periodic arrangement has a period length of less than 5 μm.

20. The diffraction grating according to claim 13, wherein the first grating material and the second grating material comprise dielectric materials.

21. The diffraction grating according to claim 13, wherein the layers of the first layer system and/or the layers of the further layer system have a first layer material and a second layer material, wherein the first layer material is identical to the first grating material and/or the second layer material is identical to the second grating material.

22. The diffraction grating according to claim 13, wherein the first layer system and/or the further layer system has at least three layers having alternating indices of refraction.

23. A method for producing a diffraction grating, the method comprising:
forming a periodic arrangement of recesses in a substrate or in a layer overlying the substrate;
forming a grating region by filling the recesses with a further solid material, so that a solid material of the substrate or layer functions as a first grating material and the further solid material functions as a second grating material, wherein the first grating material and the second grating material have different indices of refraction;
depositing a first layer system that has a plurality of layers having different indices of refraction; and
after depositing the first layer system, depositing a second layer system that includes a plurality of layers having different indices of refraction, the second layer system comprising a reflection-reducing or reflection-increasing layer system.

24. The method according to claim 23, wherein filling of the recesses with the second grating material comprises performing atomic layer deposition (ALD).

25. The method according to claim 23, wherein the diffraction grating is a reflection grating, wherein the second layer system is a reflection-increasing layer system, and wherein the first layer system is a reflection-reducing layer system.

26. The method according to claim 23, wherein the diffraction grating is a reflection grating, the second layer system is a reflection-reducing layer system, and the first layer system is a reflection-increasing layer system.

27. The method according to claim 23, wherein the first grating material and the second grating material are dielectric materials.

28. The method according to claim 23, wherein forming the periodic arrangement of recesses comprises forming the recesses in the substrate.

29. The method according to claim 23, wherein forming the periodic arrangement of recesses comprises forming the recesses the layer overlying the substrate.
